(19) United States
(12) Patent Application Publication
(10) Pub. No.: US 2007/0183620 A1
(43) Pub. Date: Aug. 9, 2007

(54) Selectable impedance, constant efficiency electromagnetic transducer

(76) Inventors: Enrique M. Stiles, Imperial Beach, CA (US); Richard C. Calderwood, Portland, OR (US)

Correspondence Address: Richard Calderwood, 2775 NW 126th Ave., Portland, OR, 97229-8381, US

(21) Appl. No.: 11/349,961

(22) Filed: Feb. 7, 2006

(51) Int. Cl. H04R 9/06; H04R 11/02; H04R 1/00

(52) U.S. Cl. 381/401; 381/405

(57) ABSTRACT

An electromagnetic transducer such as an audio speaker, having three or more voice coils disposed in one or more magnetic air gaps. The voice coils can be combined in any permutation of series/parallel connections, to select any one of a predetermined set of impedance values for the transducer. Optionally, the transducer is equipped with a set of different terminal connector plugs, each of which automatically performs the series/parallel connections for its designated impedance value. All voice coils may be selected as active, allowing for a constant maximum efficiency, regardless of which impedance option is selected.

### BACKGROUND OF THE INVENTION

1. Technical Field of the Invention

This invention relates generally to electromagnetic transducers, and more specifically to voice coil configurations for them.

2. Background Art

FIG. 1 illustrates a conventional electromagnetic transducer 10 including a motor structure 12 and a diaphragm assembly 14 coupled to a frame or basket 16. The motor structure may have an external magnet geometry, as shown, or it may have an internal magnet geometry. In the external magnet geometry, the motor structure includes a magnetically permeable (e.g. steel) pole plate 18 which includes a pole piece 20 and a back plate 21. One or more axially polarized, annular, permanent magnets 22 are magnetically coupled to the back plate, and a magnetically permeable top plate 24 is magnetically coupled to the topmost magnet. The top plate defines a magnetic air gap 26 with the pole piece.

The diaphragm assembly includes a cone or diaphragm 28 which is coupled at its outer perimeter to the frame by a flexible suspension component referred to as a surround 30. A voice coil former or bobbin 32 is coupled to the diaphragm. A flexible suspension component referred to as a spider 34 couples the bobbin (or diaphragm) to the frame. An electrically conductive voice coil 36 is wound around the bobbin and is disposed within the magnetic air gap of the motor structure. Some transducers include only a single voice coil. Some, such as that shown, include a single layer of windings. The ends of the voice coil are connected (by wires or leads not shown) to a + terminal and a − terminal, respectively. The terminals may conveniently be located at a terminal block 38.

For ease of illustration, the particular routing of the wiring from the voice coil to the terminals has been omitted from the drawings, as it is well known in the art. In various transducers, the wires are routed up the outside of the bobbin, or the inside of the bobbin, along or in the spider from the bobbin to the terminal block, or hanging in the air between the bobbin and the terminal block, or along the diaphragm, and so forth.

FIG. 2 illustrates a transducer 40 having two voice coils 42, 44, one wound on top of the other. The four ends of the two voice coils are connected to a first + terminal, a first − terminal, a second + terminal, and a second − terminal, respectively, at a terminal block 46. (Alternatively, FIG. 2 may be interpreted as illustrating a dual-layer single voice coil. By winding the voice coil downward, then upward over the downward windings, both ends of the wire exit the voice coil at its upper end. This offers some advantages in manufacturing, and in routing the wires to the terminal block.) Many dual voice coil loudspeakers have been available, such as the Orion H2 subwoofer, which is available with dual 4Ω voice coils (or, optionally, dual 2Ω voice coils). It is known, depending upon the needs of the application at hand, such as the characteristics of the amplifier, that the dual voice coils can be wired either in series or in parallel. For example, two 4Ω voice coils can be wired in series, to present the amplifier with, in effect, a single 8Ω load, or in parallel, to present the amplifier with, in effect, a single 2Ω load. The series configuration has 4× the impedance of the parallel configuration; in other words, the series configuration has 300% more impedance than the parallel configuration.

The system builder could, of course, wire only one of the voice coils, presenting a 4Ω load, which is only 2× the parallel configuration and ½× the series configuration. Unfortunately, with the other voice coil inactive, the efficiency of the transducer is remarkably reduced. Additionally, the inactive voice coil unnecessarily increases the moving mass, reducing the efficiency and limiting the high frequency range of the transducer as compared to a similar transducer which does not have the dead-weight coil.

Unfortunately, each dual voice coil transducer offers only two selectable full efficiency loads which are at best 4× different if the coils are the same impedance, and one or two reduced efficiency loads. What is needed, then, is an improved electromagnetic transducer which gives the system builder a significantly greater number of selectable impedances in increments significantly tighter than 4×, allowing the system builder to more closely match a desired impedance.

### BRIEF DESCRIPTION OF THE DRAWINGS

FIG. 1 shows an electromagnetic transducer having a single voice coil, according to the prior art.

FIG. 2 shows an electromagnetic transducer having dual voice coils (or, alternatively, a two-layer single voice coil), according to the prior art.

FIG. 3 shows a three voice coil transducer according to one embodiment of this invention.

FIGS. 4 and 5 are charts showing exemplary impedance sets of the FIG. 3 transducer, according to the voice coil impedances shown in Table 1, on a linear scale and a logarithmic scale, respectively.

FIG. 6 shows a four voice coil transducer according to another embodiment of this invention.

FIGS. 7 and 8 are charts showing exemplary impedance sets of the FIG. 6 transducer, according to the voice coil impedances shown in Table 2, on a linear scale and a logarithmic scale, respectively.

FIG. 9 shows a dual gap transducer according to yet another embodiment of this invention, where the voice coils are not all disposed in a same, single magnetic air gap.

FIGS. 10-15 show a terminal block and a ready-made set of five terminal block interface units which can be plugged into the terminal block, each selecting a predetermined one of the five voice coil series/parallel permutations taught in Table 1.

FIG. 16 shows a dual magnetic air gap embodiment of this invention, using the voice coil “hand-off” technique to extend the Xmax of the motor.

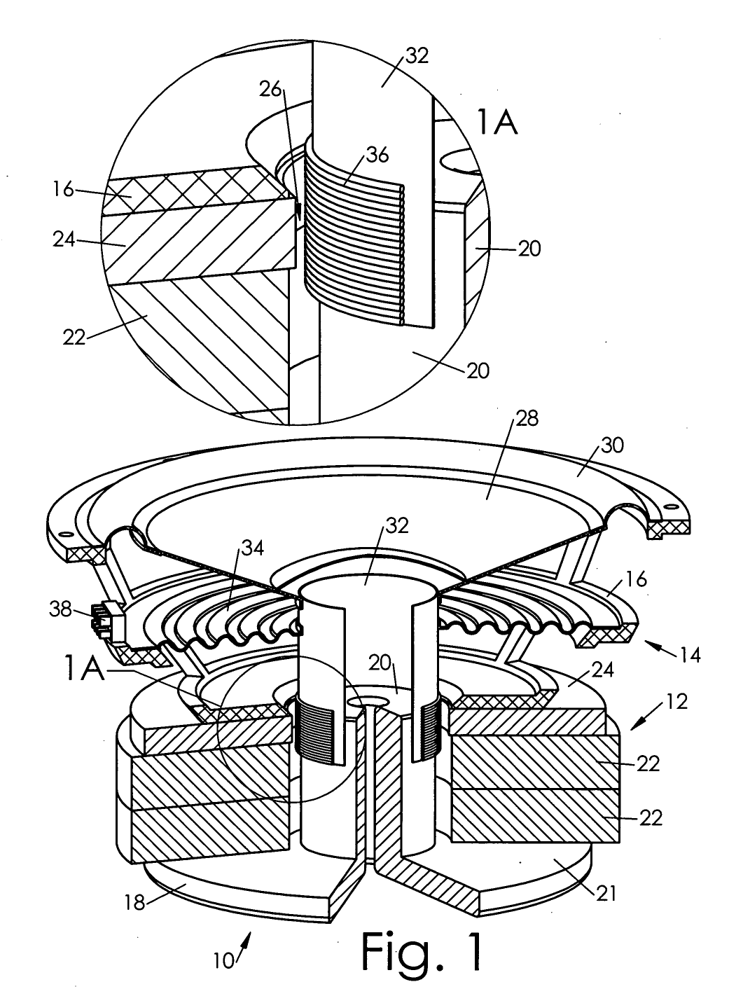

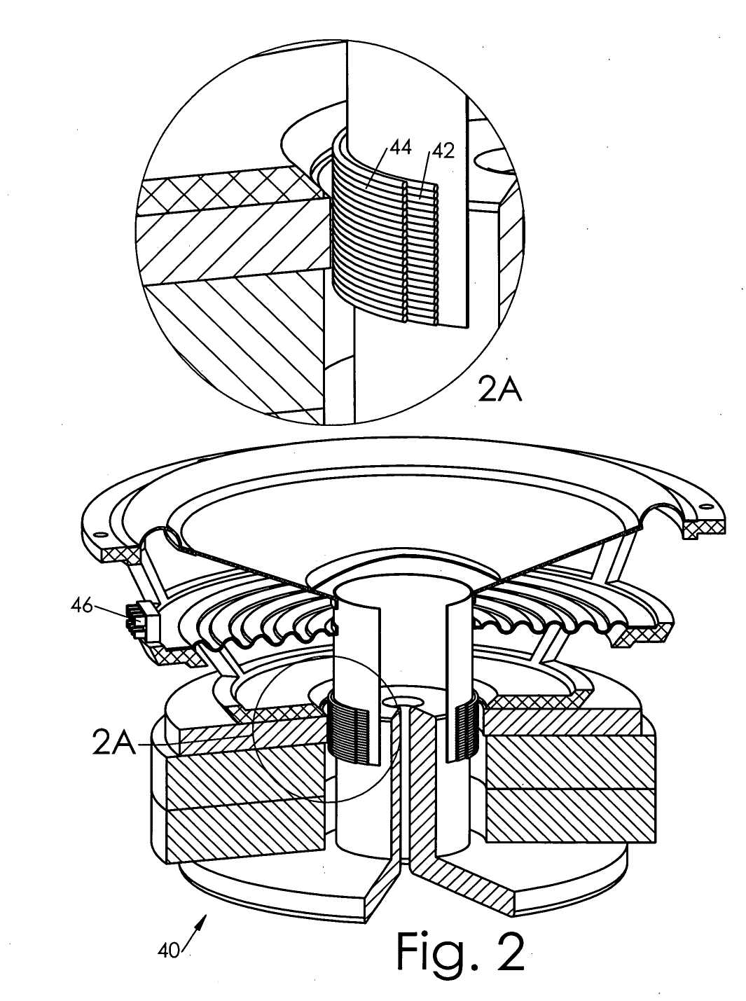

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

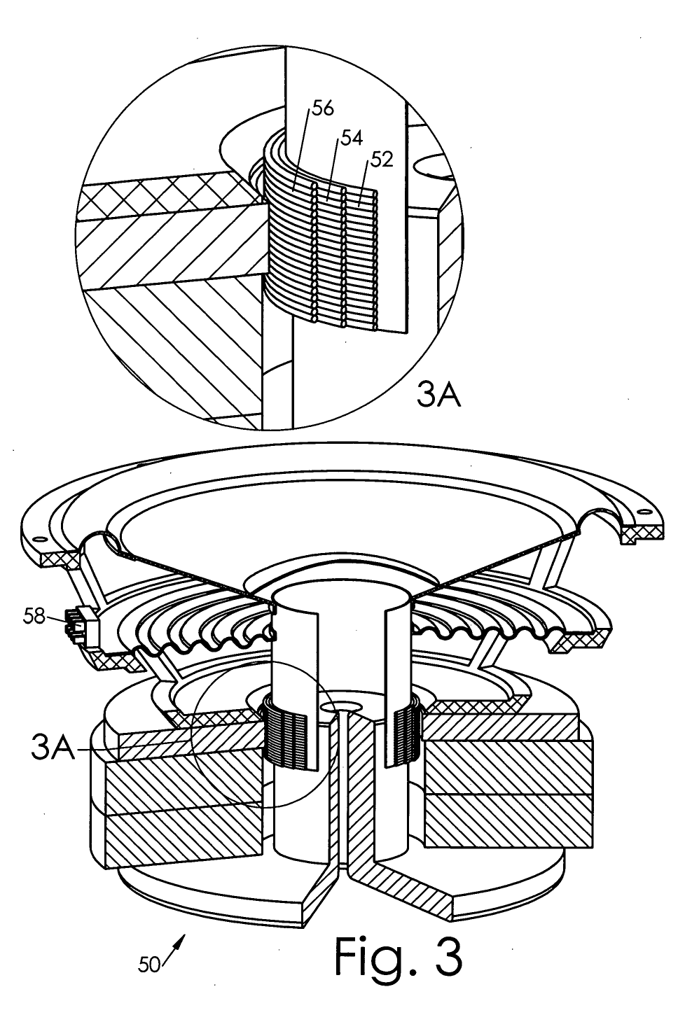

FIG. 3 illustrates an electromagnetic transducer 50 according to one embodiment of this invention. The diaphragm assembly includes three voice coils 52, 54, 56. The wires extending from the two ends of the first voice coil are connected to a first + terminal and a first − terminal, respectively; the wires extending from the two ends of the second voice coil are connected to a second + terminal and a second − terminal, respectively; and the wires extending from the two ends of the third voice coil are connected to a third + terminal and a third − terminal, respectively. The terminals may advantageously be coupled to a terminal block 58.

Having three voice coils gives an increased number of options for the system builder, and the greater the number of different impedances there are among the three coils, the more options the system builder will have. Table 1 demonstrates the impedance choices available from each of six different sets of impedances for the three voice coils.

TABLE 1
STEP Technologies Multi Voice Coil Impedance Sets - 3 Coils

| | Config 1 | Config 2 | Config 3 | Config 4 | Config 5 | Config 6 |
|---|---|---|---|---|---|---|
| VC1 | 1.00Ω | 1.00Ω | 2.00Ω | 0.80Ω | 0.30Ω | 0.20Ω |
| VC2 | 2.00Ω | 1.30Ω | 2.50Ω | 1.90Ω | 1.13Ω | 1.30Ω |
| VC3 | 3.00Ω | 1.70Ω | 3.50Ω | 3.40Ω | 1.75Ω | 2.00Ω |
| VC1\|\|VC2\|\|VC3 | 0.55Ω | 0.42Ω | 0.84Ω | 0.48Ω | 0.21Ω | 0.16Ω |
| (VC1\|\|VC2)--VC3 | 3.67Ω | 2.27Ω | 4.61Ω | 3.96Ω | 1.99Ω | 2.17Ω |
| (VC1\|\|VC3)--VC2 | 2.75Ω | 1.93Ω | 3.77Ω | 2.55Ω | 1.38Ω | 1.48Ω |
| (VC2\|\|VC3)--VC1 | 2.20Ω | 1.74Ω | 3.46Ω | 2.02Ω | 0.98Ω | 0.99Ω |
| VC1--VC2--VC3 | 6.00Ω | 4.00Ω | 8.00Ω | 6.10Ω | 3.18Ω | 3.50Ω |
| Rank | | | | | | |
| 1 | 0.55Ω | 0.42Ω | 0.84Ω | 0.48Ω | 0.21Ω | 0.16Ω |
| 2 | 2.20Ω | 1.74Ω | 3.46Ω | 2.02Ω | 0.98Ω | 0.99Ω |
| 3 | 2.75Ω | 1.93Ω | 3.77Ω | 2.55Ω | 1.38Ω | 1.48Ω |
| 4 | 3.67Ω | 2.27Ω | 4.61Ω | 3.96Ω | 1.99Ω | 2.17Ω |
| 5 | 6.00Ω | 4.00Ω | 8.00Ω | 6.10Ω | 3.18Ω | 3.50Ω |
| % more than next lower | 303.33% | 309.41% | 310.06% | 317.99% | 372.07% | 519.32% |
| | 25.00% | 11.11% | 9.09% | 26.19% | 40.24% | 50.00% |
| | 33.33% | 17.39% | 22.22% | 55.56% | 43.86% | 46.67% |
| | 63.64% | 76.58% | 73.49% | 53.93% | 59.80% | 61.04% |
| Stdev of last 3 | 0.203 | 0.361 | 0.340 | 0.165 | 0.104 | 0.075 |

The impedances of the three voice coils can be selected in any combination suitable to achieve the transducer designer's goals. Six exemplary combinations are presented here, as “Config 1” through “Config6”. The three voice coils are identified as VC1, VC2, and VC3. There are five possible ways to wire three voice coils, using all three voice coils to maintain constant, maximum efficiency:

1) all three in parallel, shown as VC1∥VC2∥VC3

2) VC1 and VC2 in parallel, and VC3 in series with them, shown as (VC1∥VC2)—VC3

3) VC1 and VC3 in parallel, and VC2 in series with them, shown as (VC1∥VC3)—VC2

4) VC2 and VC3 in parallel, and VC1 in series with them, shown as (VC2∥VC3)—VC1

5) all three in series, shown as VC1—VC2—VC3

The “Rank” subtable sorts the five net impedances of each configuration into ascending order. The “X more than next lower” subtable indicates the increase of each of the last four impedances over the next lower one (no entry is present for the lowest impedance). The “Stdev of last 3” entry indicates the standard deviation of the last three entries in the “X more” subtable, and is a measure of the log scale linearity of the four highest impedance values for that voice coil configuration.

The all-in-parallel combination will, by the mathematical relationship of parallel impedances, in many instances, be somewhat less usef uil to the system builder than the other four, and in some cases may be ignored or considered an “outlier”. For example, consider Config 6. Its four largest impedance possibilities present the system builder a log scale nearly linear progression of choices from 0.99Ω to 3.5Ω, which are very useable in e.g. car audio applications, in which amplifiers are commonly available in skus which are stable from 1Ω to 4Ω. The all-in-parallel impedance of 0.16Ω is significantly outside this range, and is not especially useable in car audio, home audio, etc. applications.

It should be noted, however, that the system builder may wish to couple two or more transducers in series, in which case the all-in-parallel outlier may, in fact, be useful. In fact, it may be the case, depending upon the voice coil impedance values chosen, and the needs of the application at hand, that any of the combinations might be undesirable or substantially redundant.

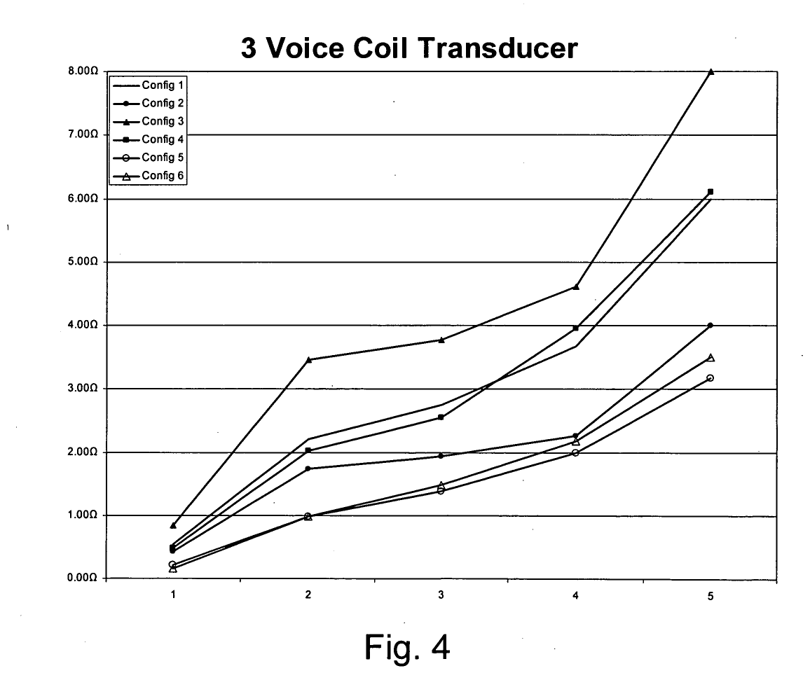

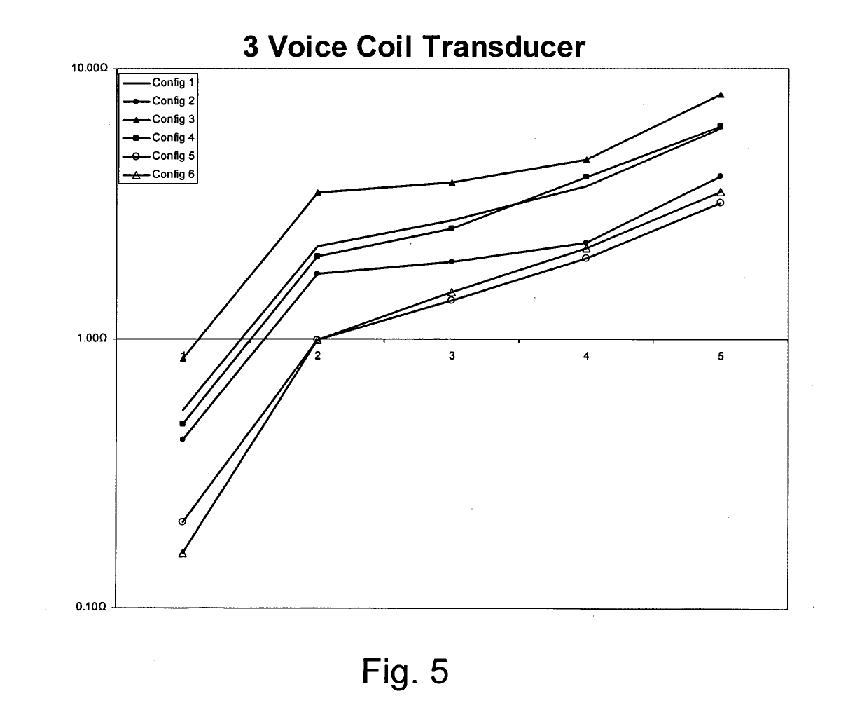

FIGS. 4 and 5 chart the “Rank” subtable on a linear scale and a logarithmic scale, respectively. The horizontal (X) axis denotes the five possible impedance values of a voice coil set. The charted lines all extend up and to the right, because the values have been sorted prior to charting; depending on the particular three voice coil impedances chosen, this may or may not correspond to the order in which the permutations were explained, four paragraphs above.

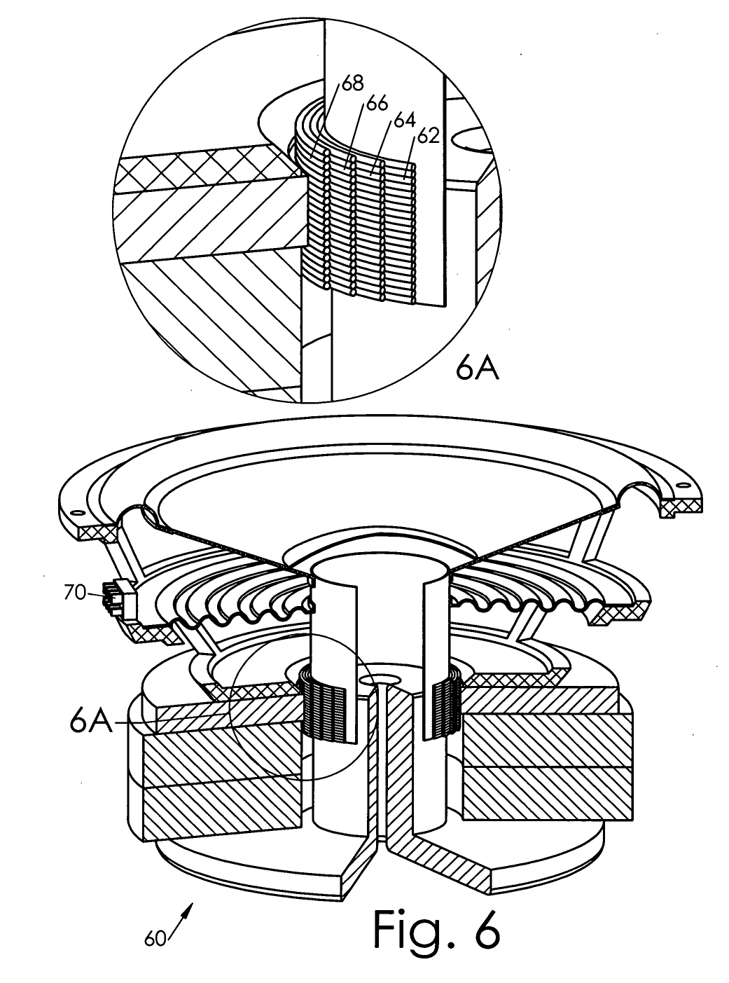

FIG. 6 illustrates an electromagnetic transducer 60 which has four voice coils 62, 64, 66, 68. The wires extending from the two ends of the first voice coil are connected to a first + terminal and a first − terminal, respectively; the wires extending from the two ends of the second voice coil are connected to a second + terminal and a second − terminal, respectively; the wires extending from the two ends of the third voice coil are connected to a third + terminal and a third − terminal, respectively; and the wires extending from the two ends of the fourth voice coil are connected to a fourth + terminal and a fourth − terminal, respectively. The terminals may advantageously be coupled to a terminal block 70.

It should be noted that, although FIGS. 3 and 6, for convenience and clarity, illustrate each voice coil as being a single layer, each voice coil may, of course, be constructed as a dual layer of windings or bifilar, trifilar, or quadfilar, etc.

Having four voice coils gives an even greater number of options for the system builder. Table 2 demonstrates the impedance choices available from each of six different sets of impedances for the four voice coils. These are, of course, only exemplary values, and the designer will select values according to the needs of the transducer's target application.

TABLE 2
STEP Technologies Multi Voice Coil Impedance Sets - 4 Coils

| | Config 1 | Config 2 | Config 3 | Config 4 | Config 5 | Config 6 |
|---|---|---|---|---|---|---|
| VC1 | 1.00Ω | 0.25Ω | 0.50Ω | 0.25Ω | 0.30Ω | 0.20Ω |
| VC2 | 2.00Ω | 0.50Ω | 0.88Ω | 1.00Ω | 1.30Ω | 1.35Ω |
| VC3 | 3.00Ω | 1.25Ω | 1.13Ω | 1.25Ω | 1.70Ω | 2.25Ω |
| VC4 | 4.00Ω | 1.75Ω | 1.50Ω | 2.00Ω | 2.00Ω | 3.00Ω |
| VC1\|\|VC2\|\|VC3\|\|VC4 | 0.48Ω | 0.14Ω | 0.21Ω | 0.16Ω | 0.19Ω | 0.15Ω |
| (VC1\|\|VC2\|\|VC3)--VC4 | 4.55Ω | 1.90Ω | 1.75Ω | 2.17Ω | 2.21Ω | 3.16Ω |
| (VC1\|\|VC2\|\|VC4)--VC3 | 3.57Ω | 1.40Ω | 1.39Ω | 1.43Ω | 1.92Ω | 2.41Ω |
| (VC1\|\|VC3\|\|VC4)--VC2 | 2.63Ω | 0.69Ω | 1.16Ω | 1.19Ω | 1.53Ω | 1.52Ω |
| (VC2\|\|VC3\|\|VC4)--VC1 | 1.92Ω | 0.55Ω | 0.87Ω | 0.68Ω | 0.84Ω | 0.86Ω |
| (VC1\|\|VC2)--(VC3\|\|VC4) | 2.38Ω | 0.90Ω | 0.96Ω | 0.97Ω | 1.16Ω | 1.46Ω |
| (VC1\|\|VC3)--(VC2\|\|VC4) | 2.08Ω | 0.60Ω | 0.90Ω | 0.88Ω | 1.04Ω | 1.11Ω |
| (VC1\|\|VC4)--(VC2\|\|VC3) | 2.00Ω | 0.58Ω | 0.87Ω | 0.78Ω | 1.00Ω | 1.03Ω |
| (VC1\|\|VC2)--VC3--VC4 | 7.67Ω | 3.17Ω | 2.94Ω | 3.45Ω | 3.94Ω | 5.42Ω |
| (VC1\|\|VC3)--VC2--VC4 | 6.75Ω | 2.46Ω | 2.72Ω | 3.21Ω | 3.56Ω | 4.53Ω |
| (VC1\|\|VC4)--VC2--VC3 | 5.80Ω | 1.97Ω | 2.38Ω | 2.47Ω | 3.26Ω | 3.79Ω |
| (VC2\|\|VC3)--VC1--VC4 | 6.20Ω | 2.36Ω | 2.49Ω | 2.81Ω | 3.04Ω | 4.04Ω |
| (VC2\|\|VC4)--VC1--VC3 | 5.33Ω | 1.89Ω | 2.18Ω | 2.17Ω | 2.79Ω | 3.38Ω |
| (VC3\|\|VC4)--VC1--VC2 | 4.71Ω | 1.48Ω | 2.02Ω | 2.02Ω | 2.52Ω | 2.84Ω |
| VC1--VC2--VC3--VC4 | 10.00Ω | 3.75Ω | 4.00Ω | 4.50Ω | 5.30Ω | 6.80Ω |
| rank | | | | | | |
| 1 | 0.48Ω | 0.14Ω | 0.21Ω | 0.16Ω | 0.19Ω | 0.15Ω |
| 2 | 1.92Ω | 0.55Ω | 0.87Ω | 0.68Ω | 0.84Ω | 0.86Ω |
| 3 | 2.00Ω | 0.58Ω | 0.87Ω | 0.78Ω | 1.00Ω | 1.03Ω |
| 4 | 2.08Ω | 0.60Ω | 0.90Ω | 0.88Ω | 1.04Ω | 1.11Ω |
| 5 | 2.38Ω | 0.69Ω | 0.96Ω | 0.97Ω | 1.16Ω | 1.46Ω |
| 6 | 2.63Ω | 0.90Ω | 1.16Ω | 1.19Ω | 1.53Ω | 1.52Ω |
| 7 | 3.57Ω | 1.40Ω | 1.39Ω | 1.43Ω | 1.92Ω | 2.41Ω |
| 8 | 4.55Ω | 1.48Ω | 1.75Ω | 2.02Ω | 2.21Ω | 2.84Ω |
| 9 | 4.71Ω | 1.89Ω | 2.02Ω | 2.17Ω | 2.52Ω | 3.16Ω |
| 10 | 5.33Ω | 1.90Ω | 2.18Ω | 2.17Ω | 2.79Ω | 3.38Ω |
| 11 | 5.80Ω | 1.97Ω | 2.38Ω | 2.47Ω | 3.04Ω | 3.79Ω |
| 12 | 6.20Ω | 2.36Ω | 2.49Ω | 2.81Ω | 3.26Ω | 4.04Ω |
| 13 | 6.75Ω | 2.46Ω | 2.72Ω | 3.21Ω | 3.56Ω | 4.53Ω |
| 14 | 7.67Ω | 3.17Ω | 2.94Ω | 3.45Ω | 3.94Ω | 5.42Ω |
| 15 | 10.00Ω | 3.75Ω | 4.00Ω | 4.50Ω | 5.30Ω | 6.80Ω |
| % more than next lower | 300.64% | 302.93% | 307.44% | 331.41% | 335.18% | 459.64% |
| | 4.00% | 5.36% | 0.39% | 13.58% | 18.99% | 20.12% |
| | 4.17% | 3.70% | 3.24% | 12.50% | 4.55% | 8.09% |
| | 14.29% | 14.89% | 6.93% | 10.77% | 11.49% | 30.97% |
| | 10.53% | 30.56% | 20.31% | 22.64% | 31.26% | 4.33% |
| | 35.71% | 56.52% | 20.00% | 20.45% | 25.63% | 58.54% |
| | 27.27% | 5.49% | 25.98% | 41.03% | 15.43% | 17.44% |
| | 3.71% | 27.70% | 15.44% | 7.30% | 13.81% | 11.49% |
| | 13.13% | 0.43% | 7.92% | 0.27% | 10.68% | 6.94% |
| | 8.75% | 3.78% | 9.06% | 13.80% | 8.92% | 12.02% |
| | 6.90% | 19.73% | 4.93% | 13.48% | 7.38% | 6.77% |
| | 8.87% | 4.29% | 9.19% | 14.36% | 9.02% | 12.12% |
| | 13.58% | 28.81% | 8.16% | 7.53% | 10.94% | 19.64% |
| | 30.43% | 18.42% | 35.91% | 30.43% | 34.39% | 25.36% |
| Stdev of last 14 | 0.106 | 0.160 | 0.102 | 0.106 | 0.094 | 0.145 |

Similar notation is used in Table 2, as was explained above regarding Table 1. Six exemplary combinations are presented here, as “Config 1” through “Config 6”. The four voice coils are identified as VC1, VC2, VC3, and VC4. There are fifteen possible ways to wire four voice coils, using all four voice coils to maintain constant, maximum efficiency:

1) VC1∥VC2∥VC3∥VC4

2) (VC1∥VC2∥VC3)—VC4

3) (VC1∥VC2∥VC4)—VC3

4) (VC1∥VC3∥VC4)—VC2

5) (VC2∥VC3∥VC4)—VC1

6) (VC1∥VC2)—(VC3∥VC4)

7) (VC1∥VC3)—(VC2∥VC4)

8) (VC1∥VC4)—(VC2∥VC3)

9) (VC1∥VC2)—VC3—VC4

10) (VC1∥VC3)—VC2—VC4

11) (VC1∥VC4)—VC2—VC3

12) (VC2∥VC3)—VC1—VC4

13) (VC2∥VC4)—VC1—VC3

14) (VC3∥VC4)—VC1—VC2

15) VC1—VC2—VC3—VC4

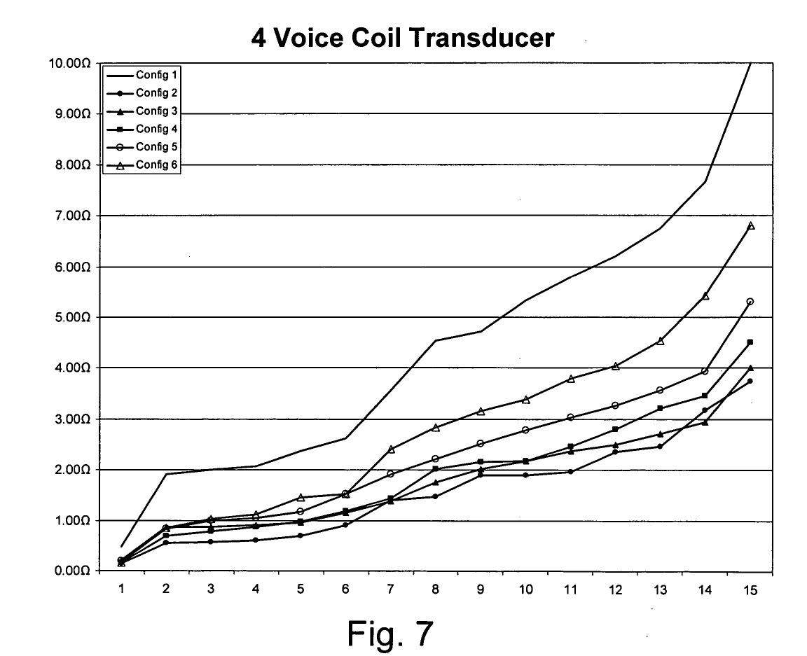

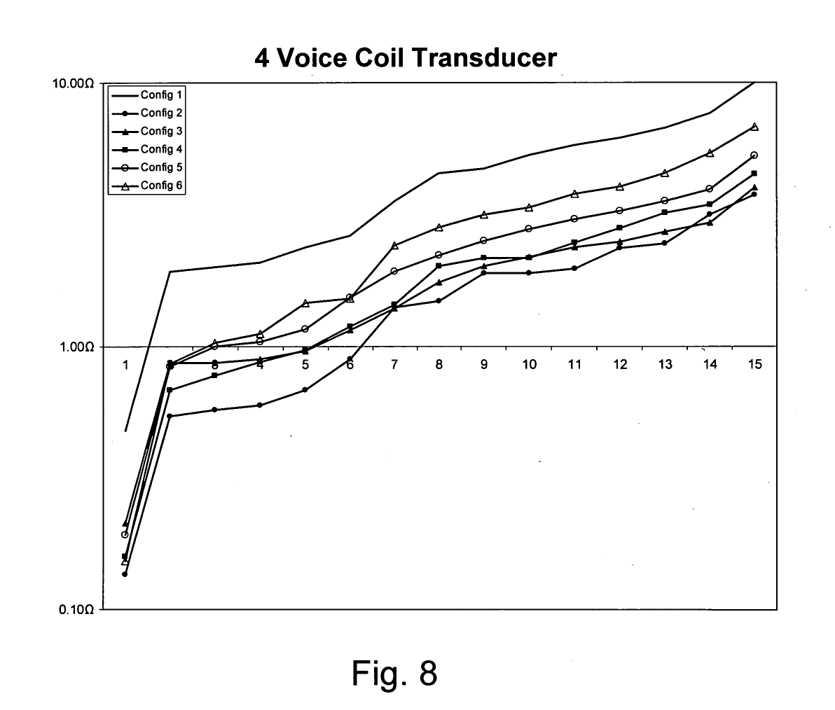

FIGS. 7 and 8 chart the “Rank” subtable on a linear scale and a logarithmic scale, respectively. The horizontal (X) axis denotes the fifteen possible impedance values of a voice coil set, sorted.

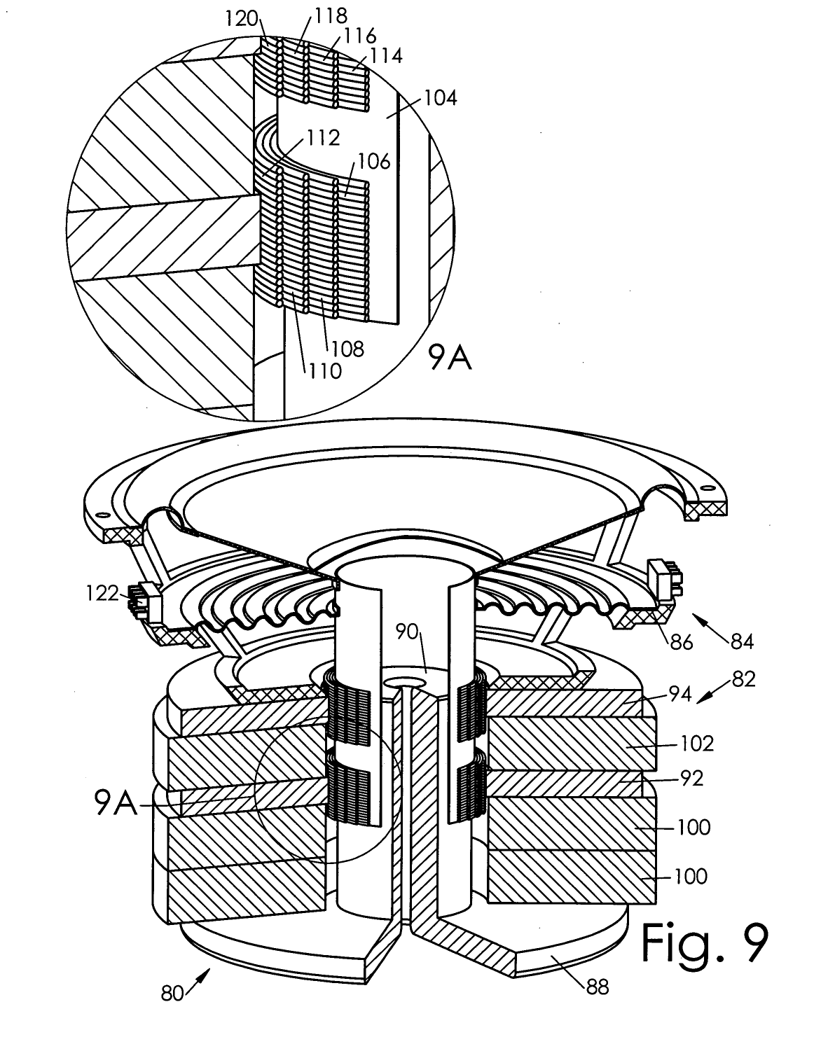

FIG. 9 illustrates an electromagnetic transducer 80 according to another embodiment of this invention. The transducer includes a motor structure 82 and a diaphragm assembly 84 coupled to a frame 86. The motor structure (which could have an internal magnet geometry but is illustrated as having an external magnet geometry) includes a poleplate 88 with a pole piece 90, as well as a lower top plate 92 and an upper top plate 94, which define a lower magnetic air gap and an upper magnetic air gap, respectively.

In one such embodiment, the motor structure uses a “push-push” dual gap geometry such as taught in U.S. Pat. No. 6,917,690, in which the magnetic flux flows in a same direction (e.g. radially inward) over both magnetic air gaps. In this case, the motor structure includes one or more permanent magnets 100 disposed between the back plate and the lower top plate. The motor structure includes a magnetically permeable member 102 disposed between the lower top plate and the upper top plate. The member 102 may be a permanent magnet, polarized in the same direction as the magnets 100, as taught in the '690 patent, or it may be a steel spacer, as taught in co-pending application Ser. No. 10/289,109, commonly assigned with the '690 patent and the present application.

In another such embodiment, the motor structure uses a “push-pull” geometry in which the magnetic flux flows in opposite directions over the two magnetic air gaps, that is, radially inward over one and radially outward over the other. In this case, elements 100 may be interpreted as aluminum spacers, and element 102 should be interpreted as a permanent magnet, with opposite polarity if elements 100 are permanent magnets rather than non-magnetic spacers.

In either the push-push or the push-pull configuration, the bobbin 104 has wound about it at least three voice coils of more than one impedance, and the magnetic air gaps each has disposed within it some subset of the voice coils. FIG. 9 illustrates four layers of voice coil windings 106, 108, 110, 112 disposed in the lower magnetic air gap, and four layers of voice coil windings 114, 116, 118, 120 disposed in the upper magnetic air gap. One magnetic air gap contains at least one voice coil, and the other magnetic air gap contains at least two voice coils. There are myriad possible ways in which the eight layers shown may be interpreted. Only a few will be explained, and the skilled reader will then be able to fully understand the possibilities taught by this disclosure.

The lower magnetic air gap may contain a first two-layer voice coil 106, 108 and a second two-layer voice coil 110, 112. The upper magnetic air gap may contain a third two-layer voice coil 114, 116 and a fourth two-layer voice coil 118, 120. The eight wires extending from the eight ends of these four voice coils are coupled to respective + and − terminals at a terminal block 122, and can then be connected in any of the fifteen combinations identified above in Table 2.

Alternatively, the lower magnetic air gap may contain a four layer voice coil 106, 108, 110, 112, and the upper magnetic air gap may contain both a three layer voice coil 114, 116, 118 and a single layer voice coil 120. The six wires extending from the six ends of these three voice coils are coupled to respective + and − terminals at the terminal block, and the system builder can select any of five configurations identified above in Table 1.

Alternatively, each magnetic air gap may contain four single layer voice coils, for a total of eight voice coils which can then be coupled in a very large number of series/parallel permutations.

Alternatively, one or both of the magnetic air gaps may contain less than four layers of voice coil windings. The reduced number of layers can be created using wire of larger diameter, resulting in the same voice coil outer diameter.

Alternatively, one or more voice coils (as determined by the wires available at the terminal block) may be present in both magnetic air gaps. For example, the layer 106 and the layer 114 may together comprise a single voice coil.

Additionally, more than two magnetic air gaps may be present in the motor structure, as taught in the '690 patent, and the three or more voice coils of the present invention may be distributed in them in any manner deemed appropriate by the transducer designer.

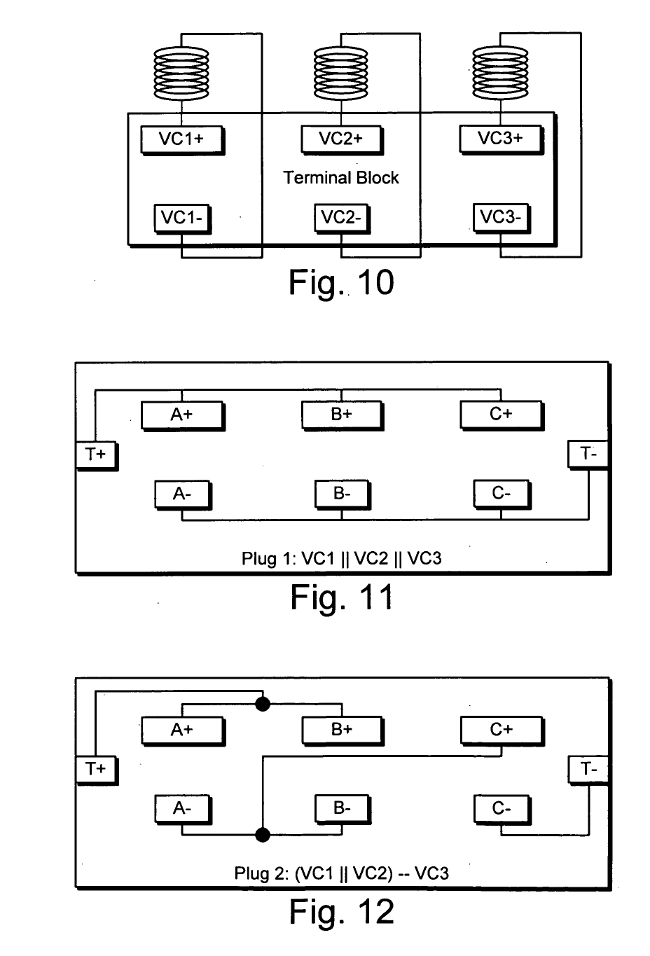

FIG. 10 illustrates a terminal block (such as 58, 70, or 122) coupled to three voice coils (such as 52, 54, 56, or such as 62/64, 66, 68, or such as 106/108/110/112, 114/116, 118/120). The terminal block may advantageously be coupled to the electromagnetic transducer (not shown), preferably but not necessarily to the frame, at an outward-facing position ideally near the outer perimeter, where it is easily reached by an system builder. The terminal block includes a first terminal connector VC1+ which is wired to the + end of the first voice coil, a second terminal connector VC 1− which is wired to the − end of the first voice coil, a third terminal connector VC2+ which is wired to the + end of the second voice coil, a fourth terminal connector VC2− which is wired to the − end of the second voice coil, a fifth terminal connector VC3+ which is wired to the + end of the third voice coil, and a sixth terminal connector VC3− which is wired to the − end of the third voice coil (It may optionally include additional terminal connectors, not shown, for wiring to the + and − ends of fourth etc. voice coils.) The terminal block has a predetermined form factor, such that the terminal connectors are in predetermined positions.

FIGS. 11-15 illustrate the five different maximum efficiency terminal block interface units, or “plugs”, each of which has a form factor for mating with the terminal block, and each providing a unique one of the series/parallel combinations listed in Table 1. (They are maximum efficiency, in that they use all of the coils. There could also be additional, reduced efficiency plugs which use less than all of the coils.) FIG. 11 illustrates Plug 1, which includes a first input terminal T+ and a second input terminal T−, at which the + and − signals, respectively, are applied from the amplifier (not shown). Plug 1 includes six terminal connectors A+, A−, B+, B−, C+, and C−, each positioned to mate with a corresponding one of the terminal connectors VC1+, VC1−, VC2+, VC2−, VC3+, and VC3−, respectively, of the terminal block of FIG. 10. In one embodiment, the terminal connectors of the terminal block are male, and the terminal connectors of the plug are female. In another embodiment, the terminal connectors of the terminal block are female, and the terminal connectors of the plug are male. In another embodiment, there is a mixture of genders in the terminal block, with some being female and others being male, and the terminal connectors of the plug are appropriately opposite. In another embodiment, each is simply a contact, with one contact of each pair being optionally spring-loaded to maintain good connection.

Any of a variety of fastening means can be used to secure the plug to the terminal block. For example, screws, bolts, elastic, hook-and-loop fasteners, clamps, clips, and so forth. Ideally, the plug is releasably secured to the terminal block, to enable the subsequent substitution of a different plug.

Plug 1 achieves the all-in-parallel configuration via wires or traces (hereinafter simply “wires”, for convenience) connecting the T+ terminal to each of the A+, B+, and C+ terminal connectors, and wires connecting the T− terminal to each of the A−, B−, and C− terminal connectors. The + input signal is thus applied via the A+ etc. terminal connectors to the VC1+ etc. terminal connectors and thence to the + end of each of the voice coils, and thence via the VC 1− etc. terminal connectors to the A− etc. terminal connectors, and thence to the T− terminal and back to the amplifier to complete the circuit.

FIG. 12 illustrates Plug 2, which provides the (VC1∥ VC2)—VC3 configuration. Plug 2 has the same form factor and includes the same terminals and terminal connectors as Plug 1. The difference between Plug 1 and Plug 2 (and the other plugs) lies in the wiring. Plug 2 includes wires connecting the T+ terminal to the A+ and B+ terminal connectors, wires connecting both the A− and B− terminal connectors to the C+ terminal connector, and the C− terminal connector to the T− terminal. With Plug 2 installed on the terminal block, the + amplifier signal is provided in parallel to both VC1 and VC2, and then in series to VC3, and then back to the amplifier.

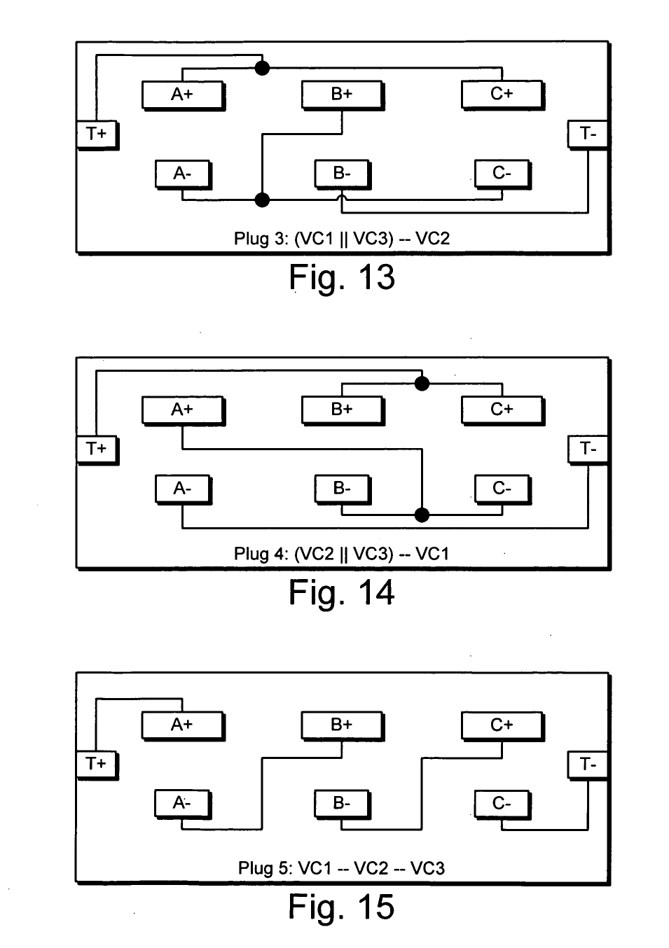

FIG. 13 illustrates Plug 3, which is wired to provide the (VC1∥VC3)—VC2 configuration, as shown.

FIG. 14 illustrates Plug 4, which is wired to provide the (VC2∥VC3)—VC1 configuration, as shown.

FIG. 15 illustrates Plug 5, which is wired to provide the all-in-series configuration. It includes a wire from the T+ terminal to the A+ terminal connector, a wire from the A− terminal connector to the B+ terminal connector, a wire from the B− terminal connector to the C+ terminal connector, and a wire from the C− terminal connector to the T− terminal.

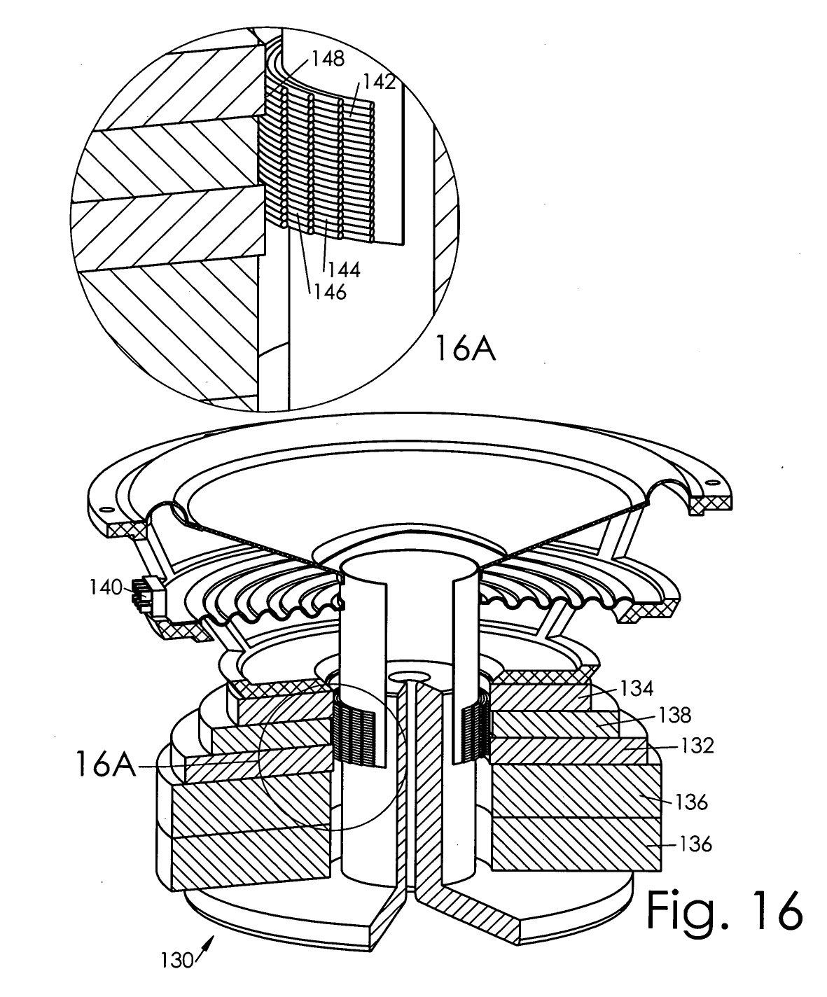

FIG. 16 illustrates a dual magnetic air gap transducer 130 according to yet another embodiment of this invention. As taught in the '690 patent, the transducer's motor structure includes a lower top plate 132 and an upper top plate 134. One or more primary magnets 136 are magnetically coupled between the lower top plate and the back plate, and a balancing magnet 138 is magnetically coupled between the lower and upper top plates. The magnets are all polarized in the same axial direction, and the magnetic flux flows in the same radial direction over both magnetic air gaps.

Three or more voice coils are disposed in the magnetic air gaps such that each coil extends substantially from the center of one gap to the center of the other gap, as shown. Minor variance may need to be made in the winding, with each next outermost layer of windings terminating slightly short of the layer over which it is wound. The layers of windings are shown as being of identical axial length, for convenience.

In one embodiment, the transducer includes a first voice coil 142, a second voice coil 144, and a third voice coil 146. In another embodiment, it further includes a fourth voice coil 148. In some embodiments, each voice coil occupies its own, dedicated layer in the voice coil assembly.

In other embodiments, a layer may include wire windings from two or more voice coils. For example, the first and second layers 142 and 144 may include alternating first and second voice coil wires such as a bifilar configuration simultaneously wound down the bobbin (layer 142) then back up the bobbin (layer 144) over the first layer; and the third and fourth layers 146 and 148 may include alternating third and fourth voice coil wires simultaneously wound down the bobbin (layer 146) and then back up the bobbin (layer 148).

The transducer includes a terminal block 140 to which the ends of each voice coil are connected. By plugging in the right terminal block interface unit (not shown), the system builder can configure the transducer to have the desired impedance.

### CONCLUSION

When one component is said to be “adjacent” another component, it should not be interpreted to mean that there is absolutely nothing between the two components, only that they are in the order indicated.

In its most simplistic configuration, a terminal connector may simply be the end of the voice coil wire, and the series/parallel connection is accomplished by joining wire ends together, e.g. by soldering them, or by fastening them with wire nuts, or the like.

The term “series/parallel” is meant to include any of the possible permutations of voice coil connections, and should not be construed as requiring both a series connection and a parallel connection.

In some embodiments, it may be acceptable to have e.g. four voice coils, with the connector plugs selecting series/parallel combinations of three or four of the voice coils. If some small number of the voice coils is unused in a configuration, the efficiency of the transducer is reduced. On the other hand, it will produce a different set of Thiele-Small small parameters (Qts will change) allowing for an alternate box tuning or different frequency response in a given box.

One significant aspect of some embodiments of this invention is that, once the appropriate terminal block interface plug has been connected, the electromagnetic transducer has only a single pair of terminals which the installer needs to connect.

The various features illustrated in the figures may be combined in many ways, and should not be interpreted as though limited to the specific embodiments in which they were explained and shown.

Those skilled in the art, having the benefit of this disclosure, will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An electromagnetic transducer comprising:
(a) a motor structure having at least one magnetic air gap; and
(b) a diaphragm assembly coupled to the motor structure and including,
(1) a diaphragm,
(2) a bobbin coupled to the diaphragm,
(3) at least three voice coils each disposed in at least one of the magnetic air gaps,
wherein at least two of the voice coils are of different impedances, and
(4) for each of the voice coils,
(i) a + terminal connector, and
(ii) a − terminal connector;
whereby the voice coils can be connected in at least four series/parallel combinations to give the electromagnetic transducer at least three different impedance values.

2. The electromagnetic transducer of claim 1 wherein:
the at least three voice coils comprises four voice coils.

3. The electromagnetic transducer of claim 1 wherein:
the at least one magnetic air gap comprises two magnetic air gaps.

4. The electromagnetic transducer of claim 3 wherein:
the at least three voice coils comprises,
a first voice coil and a second voice coil disposed in a first magnetic air gap, and
a third voice coil and a fourth voice coil disposed in a second magnetic air gap.

5. The electromagnetic transducer of claim 3 wherein:
one of the voice coils includes windings disposed in a first magnetic air gap and windings disposed in a second magnetic air gap.

6. The electromagnetic transducer of claim 1 further comprising:
a terminal block at which the + and − terminal connectors are coupled.

7. The electromagnetic transducer of claim 6 further comprising:
a plurality of interchangeable terminal block interface plugs each having
(i) a plurality of terminal connectors for mating with the terminal connectors of the terminal block,
(ii) a + input terminal and a − input terminal for receiving an input signal from an amplifier, and
each providing a unique series/parallel connection of the voice coils.

8. The electromagnetic transducer of claim 1 wherein:
each of the voice coils has a unique impedance value.

9. The electromagnetic transducer of claim 1 wherein:
at least one of the voice coils comprises a multi-layer voice coil.

10. The electromagnetic transducer of claim 1 wherein:
an impedance of a first of the voice coils is at least 10% greater than an impedance of a second of the voice coils.

11. The electromagnetic transducer of claim 10 wherein:
the impedance of the first of the voice coils is at least 25% greater than the impedance of the second of the voice coils.

12. The electromagnetic transducer of claim 10 wherein:
the impedance of the first of the voice coils is at least 20% greater than the impedance of the second of the voice coils; and
the impedance of the second of the voice coils is at least 20% greater than an impedance of a third of the voice coils.

13. An electromagnetic transducer for receiving an alternating current signal via + and − wires from an amplifier, the transducer comprising:
a frame;
a motor structure coupled to the frame and having at least one magnetic air gap;
a diaphragm assembly coupled to the frame and including a first voice coil VC1, a second voice coil VC2, and a third voice coil VC3, each voice coil disposed in at least one of the magnetic air gaps, wherein at least two of the voice coils have impedances which differ by at least 10%; and
a terminal block coupled to one of the frame and the motor structure and including,
a VC 1+ terminal connector and a VC 1− terminal connector electrically connected to respective ends of the first voice coil,
a VC2+ terminal connector and a VC2− terminal connector electrically connected to respective ends of the second voice coil,
a VC3+ terminal connector and a VC3− terminal connector electrically connected to respective ends of the third voice coil,
whereby the voice coils can be connected in any of the following series/parallel configurations by appropriate connections of the terminal connectors to each other and to the + and − wires,
1) VC1∥VC2∥ VC3
2) (VC1∥VC2)—VC3
3)(VC1∥VC3)—VC2
4) (VC2∥VC3)—VC1
5) VC1—VC2—VC3.

14. The electromagnetic transducer of claim 13 further comprising:
a set of interchangeable terminal interface plugs which are coupleable, one at a time, to the terminal block, each plug including,
a + terminal for connecting to the + wire,
a − terminal for connecting to the − wire, and
six terminal connectors each configured to mate with a respective one of the terminal connectors of the terminal block, the set including,
1) a first plug having wires connecting the + and − terminals to the six terminal connectors so as to achieve the (VC1∥VC2)—VC3 configuration,
2) a second plug having wires connecting the + and − terminals to the six terminal connectors so as to achieve the (VC1∥VC3)—VC2 configuration, and
3) a third plug having wires connecting the + and − terminals to the six terminal connectors so as to achieve the (VC2∥VC3)—VC1 configuration.

15. The electromagnetic transducer of claim 14 wherein the set further includes:
4) a fourth plug having wires connecting the + and − terminals to the six terminal connectors so as to achieve the VC1—VC2—VC3 configuration.

16. The electromagnetic transducer of claim 14 wherein the set further includes:
a fifth plug having wires connecting the + and − terminals to the six terminal connectors so as to achieve the VC1∥VC2∥VC3 configuration.

17. The electromagnetic transducer of claim 13 wherein:
the diaphragm assembly further includes a fourth voice coil VC4 disposed in at least one of the magnetic air gaps;
the terminal block further including a VC4+ terminal connector and a VC4− terminal connector electrically connected to respective ends of the fourth voice coil;
whereby the voice coils can be connected in at least six of the following series/parallel configurations by appropriate connections of the terminal connectors to each other and to the + and − wires,
1) VC1∥VC2∥VC3∥VC4
2) (VC1∥VC2∥VC3)—VC4
3) (VC1∥VC2∥VC4)—VC3
4) (VC1∥VC3∥VC4)—VC2
5) (VC2∥VC3∥VC4)—VC1
6) (VC1∥VC2)—(VC3∥VC4)
7) (VC1∥VC3)—(VC2∥VC4)
8) (VC1∥VC4)—(VC2∥VC3)
9) (VC1∥VC2)∥VC3—VC4
10) (VC1∥VC3)—VC2—VC4
11) (VC1∥VC4)—VC2—VC3
12) (VC2∥VC3)—VC—VC4
13) (VC2∥VC4)—VC1—VC3
14) (VC3∥VC4)—VC1—VC2
15) VC1—VC2—VC3—VC4.

18. The electromagnetic transducer of claim 17 further comprising:
a plurality of interchangeable terminal interface plugs which are coupleable, one at a time, to the terminal block, each plug including,
a + terminal for connecting to the + wire,
a − terminal for connecting to the − wire, and
eight terminal connectors each configured to mate with a respective one of the terminal connectors of the terminal block,
wires connected to the + and − terminals and to selected ones of the terminal connectors of the plug so as to achieve a unique one of the at least six series/parallel configurations;
whereby a desired series/parallel configuration is achieved by connecting the + and − wires to the + and − terminals, respectively, of a corresponding one of the plugs, and mating that plug with the terminal block.

19. The electromagnetic transducer of claim 17 further comprising:
a plurality of interchangeable terminal interface plugs which are coupleable, one at a time, to the terminal block, each plug including,
a + terminal for connecting to the + wire,
a − terminal for connecting to the − wire, and
at least six terminal connectors each configured to mate with a respective one of the terminal connectors of the terminal block,
wires connected to the + and − terminals and to selected ones of the terminal connectors of the plug so as to achieve a unique one of the at least four series/parallel configurations;
whereby a desired series/parallel configuration is achieved by connecting the + and − wires to the + and − terminals, respectively, of a corresponding one of the plugs, and mating that plug with the terminal block; and
wherein at least one of the interface plugs achieves a series/parallel configuration which leaves at least one of the voice coils unused.

20. The electromagnetic transducer of claim 13 wherein:
the motor structure comprises a dual gap push-push geometry motor structure including a first magnetic air gap and a second magnetic air gap.

21. The electromagnetic transducer of claim 13 wherein:
at least one of the voice coils extends from a center of the first magnetic air gap substantially to a center of the second magnetic air gap.

22. The electromagnetic transducer of claim 13 wherein:
the motor structure comprises a push-pull geometry motor structure.

23. The electromagnetic transducer of claim 13 wherein:
the motor structure includes three magnetic air gaps; and
each of the three voice coils is disposed in a respective one of the three magnetic air gaps.

24. The electromagnetic transducer of claim 13 wherein:
at least one of the voice coils comprises a two-layer voice coil.
